(19) United States
(12) Patent Application Publication
(10) Pub. No.: US 2026/0036202 A1
(43) Pub. Date: Feb. 5, 2026

(54) PISTON ASSEMBLIES AND CYLINDERS THAT CONTROL GAS FLOW

(71) Applicant: Cummins Inc., Columbus, IN (US)

(72) Inventors: Dan E. Richardson, Columbus, IN (US); William R. Sorensen, Columbus, IN (US); Callen James Schmalz, Columbus, IN (US); Marcos Manoel Valverde Pereira, Columbus, IN (US); William D. McNulty, Scipio, IN (US); Joseph A. Rennekamp, Sunman, IN (US)

(21) Appl. No.: 19/101,405

(22) PCT Filed: Jul. 24, 2023
(86) PCT No.: PCT/US2023/070829

§ 371 Date: Feb. 5, 2025

Related U.S. Application Data
(60) Provisional application No. 63/370,970, filed on Aug. 10, 2022.

(51) Int. Cl. F16J 9/22; F16J 1/09

(52) U.S. Cl. CPC F16J 9/22; F16J 1/09

(57) ABSTRACT

Pistons and/or piston rings include features to provide oil and/or gas flow past the piston rings of the piston. As a result, oil consumption due to reverse blow-by conditions is reduced or eliminated.

### Cross-Reference to Related Application

The present application claims priority to, and the benefit of the filing date of, U.S. Provisional Application Ser. No. 63/370,970 filed on Aug. 10, 2022, which is incorporated herein by reference in its entirety.

### TECHNICAL FIELD

The present application relates generally to internal combustion engines, and more particularly to features of piston assemblies and cylinders that include one or more features that control gas flow away from the combustion chamber.

### BACKGROUND

Pistons for internal combustion engines have been developed that include piston rings that extend around the piston. Piston rings are located between the piston and the adjacent bore wall of a cylinder in which the piston is positioned. Such piston rings are typically mounted in circumferential grooves of the piston.

Because of cylinder pressure in the combustion chamber, gases will flow down past the top ring into the space between the top ring and the second ring groove. If the second piston ring is on the top side of the ring groove, the second piston ring may collapse radially inward. If the second piston ring collapses radially inward, it will no longer be able to scrape oil downward and oil consumption will be increased.

Some pistons may include a passage that extends from a space above the second piston ring to a space in the groove behind the second piston ring. If the second piston ring is on the top side of the ring groove, blow-by gas that would otherwise pressurize above the second piston ring can flow through the passage to resist radial collapse of the second piston ring. As a result, gases can blow oil down from the combustion chamber, preventing radial collapse of the second piston ring, and maintaining the ability of the second piston ring to provide scraping of the bore wall, reducing oil consumption.

However, if the second piston ring is on the bottom side of the ring groove, the second piston ring will impede the flow of gases downward and allow pressure to build above the second piston ring. This may induce reverse blow-by and may result in increased oil consumption. This may occur more frequently at low engine speeds. Therefore, further improvements in this area are needed to prevent both radial piston ring collapse and to enhance the downward flow of the blow-by and oil.

### SUMMARY

Piston assemblies are provided that include pistons and/or piston rings that control gas flow away from the combustion chamber and reduce oil consumption. One embodiment is a piston assembly for a combustion chamber of an internal combustion engine. The piston assembly includes a piston with a top for orientation toward the combustion chamber, an outer surface extending downwardly from the top of the piston, and an annular groove in the outer surface. A piston ring is in the annular groove of the piston. One or more passages are configured to permit blow-by gas from the combustion chamber to bypass the piston ring in the annular groove.

Another embodiment is a piston assembly for a combustion chamber of an internal combustion engine. The piston assembly includes a piston with a top end for orientation toward the combustion chamber, an outer surface extending downwardly from the top end, and an annular groove in the outer surface. The annular groove includes a top side, a bottom side that faces the top side, and a back side extending between the top side and the bottom side. The piston assembly includes a piston ring in the annular groove of the piston. A first passage is located along the top side of the annular groove that extends from the outer surface toward the back side, a second passage is located along the bottom side of the annular groove that extends from the outer surface toward the back side, and the first and second passages are configured to permit blow-by gas from the combustion chamber to flow around the piston ring in the annular groove.

Another embodiment is a piston assembly for a combustion chamber of an internal combustion engine. The piston assembly includes a piston having a top end for orientation toward the combustion chamber, an outer surface extending downwardly from the top end, a top annular groove in the outer surface, and a second annular groove in the outer surface below the top annular groove. The piston assembly also includes a top piston ring in the top annular groove and a second piston ring in the second annular groove. The second piston ring includes a gap between a first end surface and a second end surface of the second piston ring. The gap is sized for substantially all gas from the combustion chamber that flows past the top piston ring into a space between the top piston ring and the second piston ring to pass through the gap of the second piston ring to minimize pressure buildup between the piston rings over the entire cycle under substantially all operating conditions of the internal combustion engine.

Another embodiment includes a cylinder for an internal combustion engine. The cylinder includes a combustion chamber having a bore that extends around the combustion chamber and a piston housed in the combustion chamber. The piston includes a top end oriented toward the combustion chamber, an outer surface extending along the bore wall downwardly from the top end, a top annular groove in the outer surface, and a second annular groove in the outer surface below the top annular groove. A top piston ring is in the top annular groove of the piston, and a second piston ring is in the second annular groove of the piston. A flow path is formed between adjacent ends of the second piston ring and between the bore of the combustion chamber and the outer surface of the piston. The flow path is sized for substantially all gas from the combustion chamber that flows past the top piston ring into a space between the top piston ring and the second piston ring to pass through the flow path to minimize pressure buildup between the piston rings over the entire cycle under substantially all operating conditions of the internal combustion engine.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic elevation view of a cylinder of an internal combustion engine that houses a piston assembly according to the present disclosure.

FIG. 2 is a schematic elevation of a piston according to an embodiment of the present disclosure.

FIG. 3 is a sectional view through line 3-3 of FIG. 2.

FIG. 4 is a sectional view through line 4-4 of FIG. 2.

FIG. 5 is a sectional view through line 5-5 of FIG. 2.

FIG. 6 is a partial sectional view of the piston of FIG. 2 showing piston rings positioned in the annular grooves of the piston to provide a piston assembly according to an embodiment of the present disclosure.

FIG. 7 is a partial isometric view of the piston assembly of FIG. 5 showing gas flow around the piston ring in the middle groove of the piston of FIG. 2.

FIG. 8 is a schematic view showing another embodiment of an arrangement for gas flow to bypass the piston ring in the annular groove of the piston.

FIG. 9 is a schematic view showing another embodiment of an arrangement for gas flow to bypass the piston ring in the annular groove of the piston.

FIG. 10 is a plan view of a piston ring according to another embodiment of the present disclosure.

FIG. 11 is an elevation view of the piston ring of FIG. 10.

FIG. 12 is a partial sectional view showing the piston ring of FIG. 10 positioned in an annular groove of a piston to provide a piston assembly according to another embodiment of the present disclosure.

FIG. 13 is a partial isometric view of the piston assembly of FIG. 12 showing gas flow around the piston ring of FIG. 10 in the annular groove of the piston.

### DETAILED DESCRIPTION OF ILLUSTRATIVE EMBODIMENTS

For the purposes of clearly, concisely and exactly describing exemplary embodiments of the invention, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

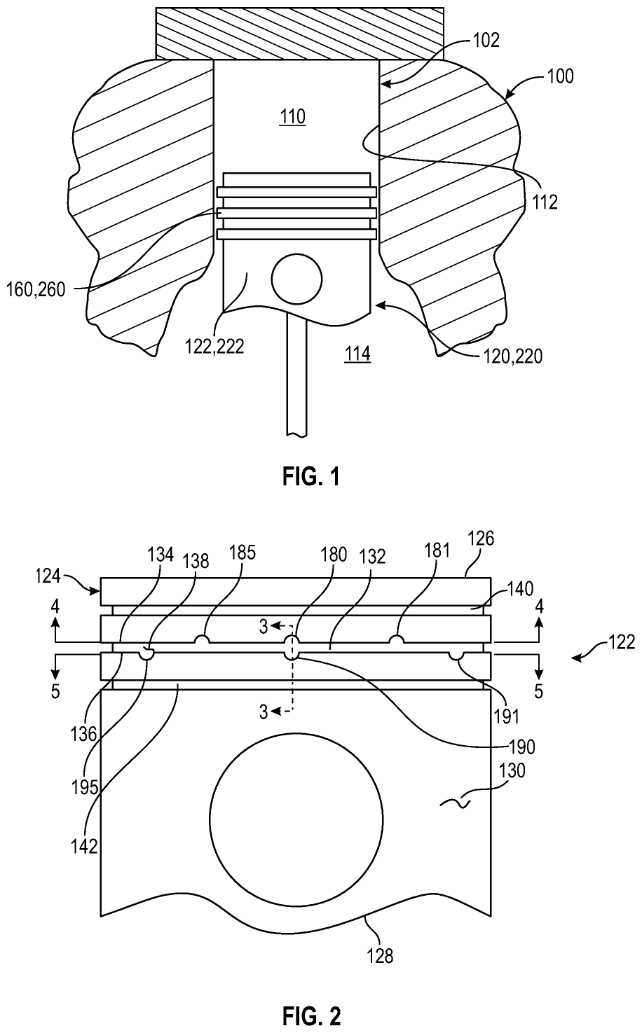

With reference to FIGS. 1-13, a piston assembly 120, 220 is provided for a combustion chamber 110 of an internal combustion engine 100. In an embodiment, piston assembly 122 includes a piston 122, 122′, 122″. Piston 122, 122′, 122″ includes a top 126 for orientation toward the combustion chamber 110, an outer surface 130 extending downwardly from the top 126 of the piston 122, 122′, 122″, and an annular groove 132 in the outer surface 130. A piston ring 160 is in the annular groove 132 of the piston 122, 122′, 122″. One or more passages 180, 190, 180′, 190′, 180″, 180″′ are configured to permit blow-by gas from the combustion chamber 110 to bypass the piston ring 160 in the annular groove 132.

In an embodiment, the piston assembly 120 includes a piston 122, 122′, 122″. The piston 122, 122′, 122″ includes a top 126 for orientation toward the combustion chamber 110. Piston 122, 122′, 122″ includes an outer surface 130 extending downwardly from the top end 126. Piston 122, 122′, 122″ includes an annular groove 132 in the outer surface 130. The annular groove 132 includes a top side 134, a bottom side 136 that faces the top side 134, and a back side 138 extending between the top side 134 and the bottom side 136. The piston assembly 120 includes a piston ring 160, 260 in the annular groove 132 of the piston 122, 122′, 122″. A first passage 180, 180′ is located along the top side 134 that extends from the outer surface 130 toward the back side 138. A second passage 190, 190′ is located along the bottom side 136 that extends from the outer surface 130 toward the back side 138. The first and second passages 180, 180′, 190, 190′ are configured to permit blow-by gas from the combustion chamber 110 to flow around the piston ring 160, 260 in the annular groove 132.

In an embodiment, a piston assembly 120, 220 for a combustion chamber 110 of an internal combustion engine 100 is provided. The piston assembly 120, 220 includes a piston 122, 122′, 122″, 222 The piston 122, 122′, 122″, 222 includes a top 126, 226 for orientation toward the combustion chamber 110. Piston 122, 122′, 122″, 222 includes an outer surface 130, 230 extending downwardly from top 126, 226. Piston 122, 122′, 122″, 222 includes a top annular groove 140 in the outer surface 130, 230, and a second annular groove 132, 232 in the outer surface 130, 230 below the top annular groove 140. The piston assembly 120, 220 also includes a top piston ring 144 in the top annular groove 140 and a second piston ring 260 in the second annular groove 132, 232. The second piston ring 260 includes a gap 268 between a first end surface 264 and a second end surface 266 of the second piston ring 260. The gap 268 is sized for substantially all gas from the combustion chamber 110 that flows past the top piston ring 144 into a space between the top piston ring 144 and the second piston ring 260 to pass through the gap 268 of the second piston ring 260 to minimize pressure buildup between the piston rings 144, 260 over the entire cycle under substantially all operating conditions of the internal combustion engine 100.

In an embodiment, a cylinder 102 for an internal combustion engine 100 is provided. The cylinder 102 includes a combustion chamber 110 having a bore wall 112 that extends around the combustion chamber 110. A piston 122, 122′, 122″, 222 is housed in the combustion chamber 110. The piston 122, 122′, 122″, 222 includes a top end 126, 226 oriented toward the combustion chamber 110. Piston 122, 122′, 122″, 222 includes an outer surface 130, 230 extending downwardly from top 126. Piston 122, 122′, 122″, 222 includes a top annular groove 140 in the outer surface 130, 230, and a second annular groove 132, 232 in the outer surface 130, 230 below the top annular groove. A top piston ring 144 is in the top annular groove 140 of the piston 122, 122′, 122″, 222, and a second piston ring 260 is in the second annular groove 132, 232 of the piston 122, 122′, 122″, 222. A flow path 280 is formed between adjacent ends 264, 266 of the second piston ring 260 and between the bore wall 112 of the combustion chamber 110 and the outer surface 130, 230 of the piston 122, 122′, 122″, 222. The flow path 280 is sized for substantially all gas from the combustion chamber 110 that flows past the top piston ring 144 into a space between the top piston ring 144 and the second piston ring 260 to pass through the flow path 280 to minimize pressure buildup between the piston rings 144, 260 over the entire cycle under substantially all operating conditions of the internal combustion engine 100.

Referring to FIG. 1, an internal combustion engine 100 includes a cylinder 102 and a crankcase 114 below cylinder 102. Cylinder 102 includes a combustion chamber 110. A bore wall 112 extends around the combustion chamber 110. Cylinder 102 includes a piston assembly 120, 220 having a piston 122, 122′, 122″, 222 in combustion chamber 110. Piston 122, 122′, 122″, 222 reciprocates in combustion chamber 110 along bore wall 112 during operation of engine 102 to rotate a crankshaft (not shown).

Piston assembly 120, 220 includes at least one piston ring 160, 260 that extends around piston 122, 122′, 122″, 222 and projects outwardly from piston 122, 122′, 122″, 222 toward bore wall 112. The present disclosure provides piston assemblies 120, 220 that allow gases from combustion in combustion chamber 110 to flow away from combustion chamber 119 without being trapped above piston ring 160, 260. Piston assemblies 120, 220 thereby reduce oil consumption during the entire cycle of and all, or substantially all, torque and/or operating conditions of engine 100 due to reverse blow-by conditions that blow oil past the piston rings and into combustion chamber 110. As a result, blow-by gas flow along piston assemblies 120, 220 is optimized, oil drain intervals can be extended, and engine component life can be extended

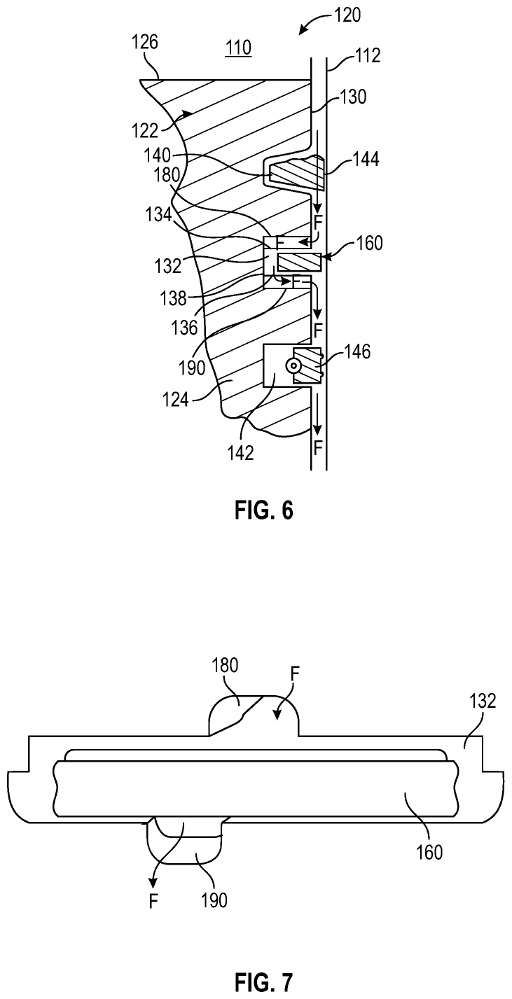

Referring to FIG. 2, piston 122 is shown. Piston 122 extends from a top end 126 oriented toward combustion chamber 110 to an opposite bottom 128. Piston 122 includes an outer surface 130, and an annular groove 132 that extends into outer surface 130 around piston 122. Annular groove 132 receives piston ring 160 (FIGS. 1, 6.)

In an embodiment, annular groove 132 is a middle groove, and piston 122 includes a head 124 with an upper or top annular groove 140 above annular groove 132 and a lower or bottom annular groove 142 below annular groove 132. As shown in FIG. 6, additional piston rings 144, 146 can be located in annular grooves 140, 142. In an embodiment, bottom piston ring 146 is an oil control ring that includes a gap between adjacent end of oil control ring 146, while piston rings 160, 144 are compression-type piston rings. In other embodiments, four or more annular grooves and piston rings are provided, and the piston ring 160 is in an annular groove below the top annular groove 140 and top piston ring 144.

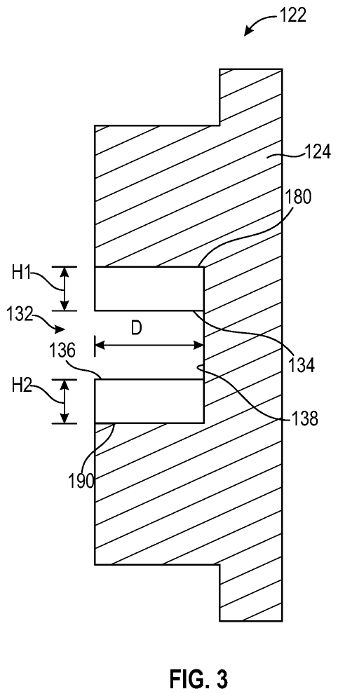

Referring further to FIG. 3, annular groove 132 includes a top side 134 and an opposite bottom side 136. A back side 138 extends from top side 134 to bottom side 136. In the illustrated embodiment, annular groove 132 includes a rectangular shape formed by sides 134, 136, 138, but other, non-rectangular shapes are also contemplated for annular groove 132.

Head 124 of piston 122 further includes a first passage 180 and a second passage 190 to facilitate blow-by gases trapped between piston rings 144, 160 to bypass the piston ring 160 in the annular groove 132. First passage 180 is located along top side 134 and extends along the top side 134 from the outer surface 130 toward the back side 138. Second passage 190 is located along the bottom side 136 and extends from the outer surface 130 toward the back side 138. As a result, blow-by gases are provided a path for travel to bypass piston ring 160 regardless of the change of position of piston ring 160 in annular groove 132 during engine operation.

In an embodiment, first passage 180 is a channel formed in piston head 124 that extends into top side 134 from outer surface 130 toward back side 138. In an embodiment, the channel extends to back side 138. First passage 180 can include a height H1 from top side 134 into head 124, and a depth D from outer surface 130 into head 124.

In an embodiment, second passage 190 is a channel formed in piston head 124 that extends into bottom side 136 from outer surface 130 toward back side 138. In an embodiment, the channel extends to back side 138. Second passage 180 can include a height H2 from bottom side 136 into head 124, and a depth D from outer surface 130 into head 124.

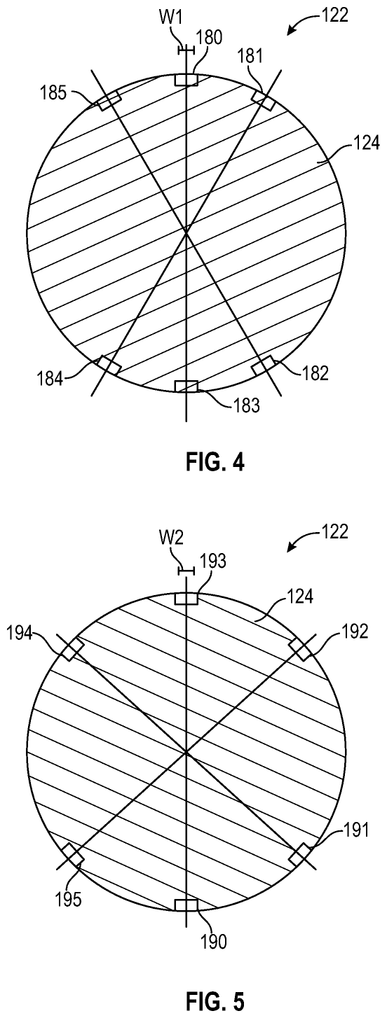

Depth D can extend to back side 138, or to a location between outer surface 130 and back side 138. Height H1 can be equal to height H2, or the heights H1, H2 can be unequal. Referring further to FIGS. 4-5, passages 180, 190 can also include a width W1 and a width W2, respectively, along outer surface 130. Widths W1 and W2 can be the same, or can be different widths. In addition, widths W1 and W2 can be the same as height H1 and/or height H2, or can be different depending on the side of the gas flow passage that is desired.

In an embodiment, the first passage 180 defines a semi-cylindrical shape in the top side 134 of the annular groove 132, and the second passage 190 defines a semi-cylindrical shape in the bottom side 136 of the annular groove 132. Other shapes are also contemplated, such as square, rectangular, oval, or irregular shapes for one or both of the passages 180, 190.

It is contemplated that only one first passage 180 and only one second passage 190 can be employed with piston 122 to accomplish the gas flow objectives of the present disclosure. However, multiple first passages 180, 181, 182, 183, 184, 185 and/or multiple second passages 190, 191, 192, 193, 194, 195 in piston head 124 around annular groove 132 are also contemplated, as shown in FIGS. 4-5. Paired ones of the upper and lower passages may be aligned circumferentially around head 124 as shown with respect to gas passage 180, 190 and 183, 193. Paired ones of the upper and lower passages may also be offset circumferentially from one another, as shown with respect to passage pairs 181, 191 and 182, 192 and 184, 194 and 185, 195.

The number of first passages 180 can be any number of one or more passages. The number of second passages 190 can be any number of one or more passages. In embodiments with multiple first passage 180-185 and multiple second passages 190-195, all the first passages 180-185 are aligned with a respective one of the second passages 190-195 in one embodiment. In another embodiment, none of the first passages 180-185 is aligned with a second passage 190-195. In another embodiment, a combination of aligned and offset passages 180-185, 190-195 may be employed as shown in FIGS. 4-5. In addition, the number of first passages 180-185 can be the same as or different from the number of second passages 190-195.

Referring to FIGS. 6-7, piston assembly 122 allows gas flow F to occur around piston ring 160 through first and second passages 180, 190. As a result, gas is not trapped in the space between piston rings 144, 160, or trapped in annular groove 132 behind piston ring 160. In addition, oil scraping by piston ring 160 can be improved by reducing incidences of radial collapse of piston ring 160.

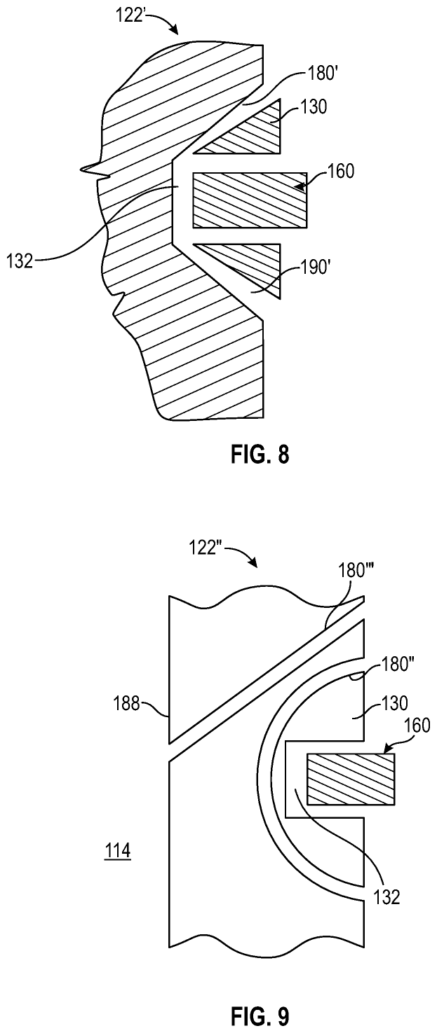

FIG. 8 shows another embodiment piston 122′. Piston 122′ can be similar to piston 122 discussed above. However, piston 122′ includes a first passage 180′ that extends into the head of piston 122′ from outer surface 130 to annular groove 132, and a second passage 190′ that extends into the head of piston 122′ from outer surface 130 to annular groove 132. The passages 180′, 190′ are therefore not open-sided grooves formed in the top and bottom sides of the annular groove 132, but are flow paths that extend through piston 122′ that are completely enclosed by the material of piston 122′. Embodiments which combine one or more passages 180, 190 with one or more passages 180′, 190′ are also contemplated.

FIG. 9 shows another embodiment piston 122″. Piston 122″ can be similar to piston 122 discussed above. However, piston 122″ includes a passage 180″ through piston 122″ that does not intersect groove 132 but configured to permit blow-by gas from the combustion chamber 110 to bypass the piston ring 160. In one example, passage 180″ extends into the head of piston 122″ from outer surface 130 at a location above annular groove 132 to a location below annular groove 132, without intersecting annular groove 132 so the annular groove 132 is completely bypassed. Multiple passages 180″ can be provided in piston 122′, or a single passage 180″. In addition, passage 180″ may be combined with one or more the other passage embodiments disclosed herein.

Alternatively, the single passage 180″′ can extend from outer surface 130 at a location above annular groove 132 and through piston 122″ to an outlet at an internal chamber or cavity 188 of piston 122′ that is directly vented to crankcase 114. Multiple passages 180″′ can be provided in piston 122′, or a single passage 180″′. In addition, passage 180″′ may be combined with one or more the other passage embodiments disclosed herein.

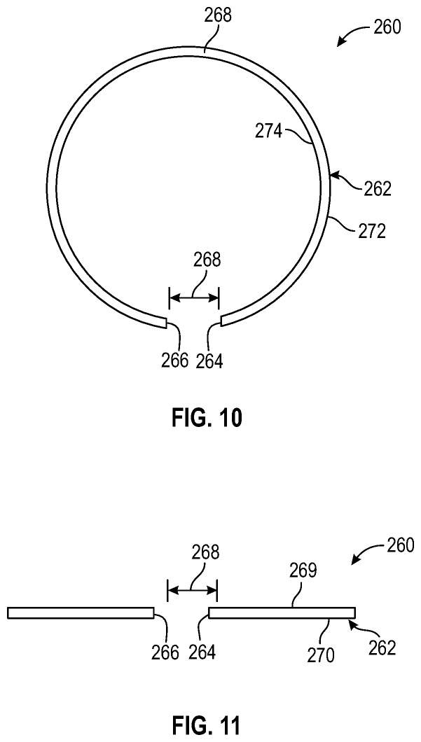

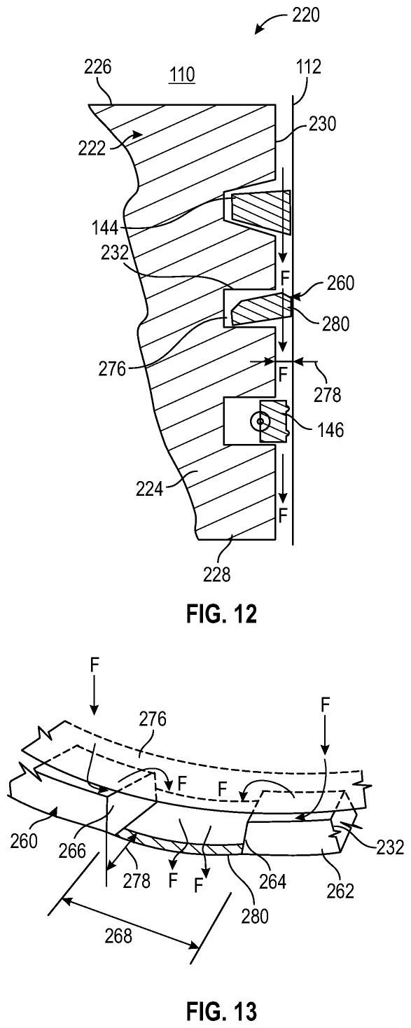

Referring to FIGS. 10-11, another embodiment piston ring 260 is shown. Piston ring 260 can be employed with piston 222 in a piston assembly 220 as shown in FIGS. 12-13, or with piston 122 in annular groove 132 thereof. In FIGS. 12-13, piston ring 260 is located in the annular groove 232 of the head 224 of the piston 222. Piston 222 is similar to piston 122 discussed above, except piston 222 need not include one or more passages for bypass of the blow-by gas. However, the presence of one or more passages as discussed above is not precluded in piston 222.

Piston 222 includes head 224 that has top end 226 for orientation toward the combustion chamber and an opposite bottom 228. Head 224 includes outer surface 230, and at least one annular groove 232 in outer surface 230. Head 224 may also include additional annular grooves above and below annular groove 232 for piston rings 144, 146 as discussed above with respect to piston 122. In addition, annular groove 232 can be configured like annular groove 132 discussed above.

The piston ring 260 includes a ring-shaped body 262 extending from first end surface 264 to second end surface 266 so that gap 268 is formed between the first end surface 264 and the second end surface 266. The gap 268 is configured to permit gas from the combustion chamber 110 that flows into the inter-ring space above annular groove 232 during an entire engine cycle to pass through the gap 268 under all or substantially all operating conditions of the internal combustion engine 100. As used herein, an entire cycle of engine 100 is four strokes of piston 222 in combustion chamber 110 that occur during 720 degrees of rotation of a crankshaft connected to piston 222.

In an embodiment, gap 268 is sized for substantially all gas from the combustion chamber 110 that flows past the top piston ring 144 into a space between the top piston ring 144 and the piston ring 260 to pass through the gap 268 to minimize pressure buildup between the piston rings 144, 160 over the entire cycle of and under substantially all operating conditions of the internal combustion engine 100.

In an embodiment, the operating conditions of engine 100 in which the pressure buildup is minimized include all or substantially all speed and torque conditions of engine 100. As a result, the gas pressure between piston rings 144, 260 is maintained at a relatively lower pressure over the entire cycle than prior art piston rings with gaps that are not sized accordingly. The piston ring 260 prevents or minimizes pressure buildup between rings 144, 260 under operating conditions such as those that occur at lower engine speeds (e.g. 25% or less of rated engine speed.)

Ring-shaped body 262 of piston ring 260 includes a top side 269 and an oppositely facing bottom side 270. The top and bottom sides 269, 270 further extend from an outer side 272 of the ring-shaped body 262 to an inner side 274 of the ring-shaped body 262. The top and bottom sides 269, 270 and the outer and inner sides 272, 274 extend from the first end surface 264 to the second end surface 266.

Gap 268 is formed by the spacing between end surfaces 264, 266 of ring-shaped body 262 to provide an escape path for the flow of gas above piston ring 260. In an embodiment, gap 268 is at least 3 millimeters in order to provide an escape path of sufficient width for the flow of gas through gap 268. In an embodiment, gap 268 is at least 4 millimeters in order to provide an escape path of sufficient width for the flow of gas through gap 268. In an embodiment, gap 268 is at least 5 millimeters in order to provide an escape path of sufficient width for the flow of gas through gap 268. In an embodiment, gap 268 is at least 6 millimeters in order to provide an escape path of sufficient width for the flow of gas through gap 268. In an embodiment, gap 268 is 8 millimeters in order to provide an escape path of sufficient width for the flow of gas through gap 268.

Gas flow F from the space between piston rings 144, 260 can escape from the space 276 behind piston ring 260 in annular groove 232 and from the inter-ring space above piston ring 260 by flowing through gap 268. Gap 268, along with clearance 278 between outer surface 230 of piston head 224 and bore wall 112 of combustion chamber 110, form a flow path 280 for gas flow F through piston ring 260 for the gas that flows from above piston ring 260. In an embodiment, this flow path 280 is a product of the size of gap 268 and clearance 278.

In an embodiment, the product of gap 268 and clearance 278 is at least 2.5 square millimeters in order to provide a flow path 280 of sufficient area for the flow of gas through piston ring 260. In an embodiment, flow path 280 is sized for substantially all gas from the combustion chamber 110 that flows past the top piston ring 144 into a space between the top piston ring 144 and the piston ring 260 to pass through the flow path 280 to minimize pressure buildup between the piston rings 144, 260 over the entire cycle under substantially all operating conditions of the internal combustion engine 100.

Various aspects of the present disclosure are contemplated, examples of which are provided in the claims appended hereto. According to one aspect, a piston assembly for a combustion chamber of an internal combustion engine is provided. The piston assembly includes a piston. The piston includes a top for orientation toward the combustion chamber, an outer surface extending downwardly from the top of the piston, and an annular groove in the outer surface. The piston assembly also includes a piston ring in the annular groove of the piston, and one or more passages that are configured to permit blow-by gas from the combustion chamber to bypass the piston ring in the annular groove.

In an embodiment, the one or more passages extend through the piston from the outer surface to the annular groove. In an embodiment, the one or more passages extend from the outer surface and through the piston from above the annular groove to below the annular groove and completely bypass the annular groove.

In an embodiment, the one or more passages extend from the outer surface of the piston along top and bottom sides of the annular groove. In an embodiment, the one or more passages extend from the outer surface of the piston at a location above the annular groove to an outlet vented directly to the crankcase.

According to another aspect, a piston assembly for a combustion chamber of an internal combustion engine is provided. The piston assembly includes a piston. The piston includes a top for orientation toward the combustion chamber, an outer surface extending downwardly from the top of the piston, and an annular groove in the outer surface. The annular groove includes a top side, a bottom side that faces the top side, and a back side extending between the top side and the bottom side. A first passage is located along the top side of the annular groove that extends from the outer surface toward the back side of the annular groove. A second passage is located along the bottom side of the annular groove that extends from the outer surface toward the back side of the annular groove. The piston assembly also includes a piston ring in the annular groove of the piston. The first and second passages are configured to permit blow-by gas from the combustion chamber to flow around the piston ring in the annular groove.

In an embodiment, the piston assembly includes a top annular groove in the outer surface, and the top annular groove is located between the annular groove and the top of the piston. A top piston ring is in the top annular groove. In a further embodiment, the piston assembly includes a bottom annular groove in the outer surface of the piston, and the bottom annular groove is located below the annular groove. An oil control ring is in the bottom annular groove.

In an embodiment, the first passage includes a plurality of first passages positioned circumferentially around the annular groove, and the second passage includes a plurality of second passages positioned circumferentially around the annular groove. In a further embodiment, the plurality of first passages are spaced from one another at a first angular spacing around the annular groove, the plurality of second passages are spaced from one another at a second angular spacing around the annual groove, and the first angular spacing is different from the second angular spacing.

In an embodiment, the first passage is a channel that extends from the outer surface of the piston to the top side of the annular groove, and the second passage is a channel that extends from the outer surface of the piston to the bottom side of the annular groove.

In an embodiment, the first passage defines a semi-cylindrical shape in the top side of the annular groove, and the second passage defines a semi-cylindrical shape in the bottom side of the annular groove.

In an embodiment, the piston ring includes a first side that faces the top side of the annular groove and a second side opposite the first side. The second side faces the bottom side of the annular groove. The first side and the second side of the piston ring extend from a first end surface to a second end surface. The first end surface is spaced from the second end surface by a gap that is configured to permit exit of blow-by gas from the first annular groove.

According to another aspect, a piston assembly for a combustion chamber of an internal combustion engine is provided. The piston assembly includes a piston. The piston includes a top for orientation toward the combustion chamber, an outer surface extending downwardly from the top of the piston, a top annular groove in the outer surface, and a second annular groove in the outer surface below the top annular groove. The piston assembly further includes a top piston ring in the top annular groove, and a second piston ring in the second annular groove of the piston. The second piston ring includes a gap between a first end surface and a second end surface. The gap is sized for substantially all gas from the combustion chamber that flows past the top piston ring into a space between the top piston ring and the second piston ring to pass through the gap to minimize pressure buildup between the piston rings over the entire cycle under substantially all operating conditions of the internal combustion engine.

In an embodiment, the gap is at least 3 millimeters. In an embodiment, the piston ring includes a top side and an oppositely facing bottom side. The top and bottom sides extend from an outer side of the piston ring to an inner side of the piston ring, and the top and bottom sides and the outer and the inner sides of the piston ring all extend from the first end surface to the second end surface.

In an embodiment, the piston assembly includes a bottom annular groove in the outer surface of the piston, and the second annular groove is located between the top annular groove and the bottom annular groove. An oil control ring housed in the bottom annular groove, and the oil control ring includes a gap.

In another aspect, a cylinder for an internal combustion engine is provided. The cylinder includes a bore wall that extends around a combustion chamber and a piston housed in the combustion chamber. The piston includes a top oriented toward the combustion chamber, an outer surface extending downwardly from the top of the piston along the bore wall of the combustion chamber, a top annular groove in the outer surface, and a second annular groove in the outer surface below the top annular groove. A top piston ring is located in the top annular groove of the piston, and a second piston ring in the second annular groove of the piston. A flow path is provided that is sized for substantially all gas from the combustion chamber that flows past the top piston ring into a space between the top piston ring and the second piston ring to pass through the flow path to minimize pressure buildup between the piston rings over the entire cycle under substantially all operating conditions of the internal combustion engine. The flow path is formed between adjacent ends of the second piston ring and between the bore wall of the combustion chamber and the outer surface of the piston.

In an embodiment, the flow path has a first dimension formed by a spacing between the adjacent ends of the second piston ring and a second dimension formed by a spacing between the outer surface of the piston and the bore wall of the combustion chamber. In an embodiment, an area formed by the first dimension and the second dimension is at least 2.5 square millimeters.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

It should be understood that while the use of words such as preferable, preferably, preferred or more preferred if utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A piston assembly for a combustion chamber of an internal combustion engine, the piston assembly comprising:
a piston including:
a top for orientation toward the combustion chamber;
an outer surface extending downwardly from the top of the piston; and
an annular groove in the outer surface;
a piston ring in the annular groove of the piston; and
one or more passages that are configured to permit blow-by gas from the combustion chamber to bypass the piston ring in the annular groove.

2. The piston assembly of claim 1, wherein the one or more passages extend through the piston from the outer surface to the annular groove.

3. The piston assembly of claim 1, wherein the one or more passages extend from the outer surface and through the piston from above the annular groove to below the annular groove and completely bypass the annular groove.

4. The piston assembly of claim 1, wherein the one or more passages extend from the outer surface of the piston along top and bottom sides of the annular groove.

5. The piston assembly of claim 1, wherein the one or more passages extend from the outer surface of the piston at a location above the annular groove to an outlet vented directly to the crankcase.

6. A piston assembly for a combustion chamber of an internal combustion engine, the piston assembly comprising:
a piston including:
a top for orientation toward the combustion chamber;
an outer surface extending downwardly from the top of the piston;
an annular groove in the outer surface, the annular groove including a top side, a bottom side that faces the top side, and a back side extending between the top side and the bottom side;
a first passage is located along the top side of the annular groove that extends from the outer surface toward the back side of the annular groove;
a second passage is located along the bottom side of the annular groove that extends from the outer surface toward the back side of the annular groove; and
a piston ring in the annular groove of the piston, wherein,
the first and second passages are configured to permit blow-by gas from the combustion chamber to flow around the piston ring in the annular groove.

7. The piston assembly of claim 6, further comprising:
a top annular groove in the outer surface, the top annular groove located between the annular groove and the top of the piston; and
a top piston ring in the top annular groove.

8. The piston assembly of claim 7, further comprising:
a bottom annular groove in the outer surface of the piston, the bottom annular groove being located below the annular groove; and
an oil control ring in the bottom annular groove.

9. The piston assembly of claim 6, wherein:
the first passage includes a plurality of first passages positioned circumferentially around the annular groove; and
the second passage includes a plurality of second passages positioned circumferentially around the annular groove.

10. The piston assembly of claim 9, wherein:
the plurality of first passages are spaced from one another at a first angular spacing around the annular groove; and
the plurality of second passages are spaced from one another at a second angular spacing around the annual groove; and
the first angular spacing is different from the second angular spacing.

11. The piston assembly of claim 6, wherein:
the first passage is a channel that extends from the outer surface of the piston to the top side of the annular groove; and
the second passage is a channel that extends from the outer surface of the piston to the bottom side of the annular groove.

12. The piston assembly of claim 6, wherein:
the first passage defines a semi-cylindrical shape in the top side of the annular groove; and
the second passage defines a semi-cylindrical shape in the bottom side of the annular groove.

13. The piston assembly of claim 6, wherein the piston ring includes:
a first side that faces the top side of the annular groove;
a second side opposite the first side, the second side facing the bottom side of the annular groove; and
the first side and the second side of the piston ring extend from a first end surface to a second end surface, and wherein the first end surface is spaced from the second end surface by a gap that is configured to permit exit of blow-by gas from the first annular groove.

14. A piston assembly for a combustion chamber of an internal combustion engine, the piston assembly comprising:
a piston including:
a top for orientation toward the combustion chamber;
an outer surface extending downwardly from the top of the piston;
a top annular groove in the outer surface; and
a second annular groove in the outer surface below the top annular groove;
a top piston ring in the top annular groove; and
a second piston ring in the second annular groove of the piston, the second piston ring including a gap between a first end surface and a second end surface, wherein the gap is sized for substantially all gas from the combustion chamber that flows past the top piston ring into a space between the top piston ring and the second piston ring to pass through the gap to minimize pressure buildup between the piston rings over the entire cycle under substantially all operating conditions of the internal combustion engine.

15. The piston assembly of claim 14, wherein the gap between the first end surface and the second end surface of the second piston ring is at least 3 millimeters.

16. The piston assembly of claim 14, wherein:
the piston ring includes a top side and an oppositely facing bottom side;
the top and bottom sides extend from an outer side of the piston ring to an inner side of the piston ring; and
the top and bottom sides and the outer and the inner sides of the piston ring all extend from the first end surface to the second end surface.

17. The piston assembly of claim 14, further comprising:
a bottom annular groove in the outer surface of the piston, wherein the second annular groove is located between the top annular groove and the bottom annular groove; and
an oil control ring housed in the bottom annular groove, wherein the oil control ring includes a gap.

18. A cylinder for an internal combustion engine, the cylinder comprising:
a bore wall that extends around a combustion chamber;
a piston housed in the combustion chamber, the piston including:
a top oriented toward the combustion chamber;
an outer surface extending downwardly from the top of the piston along the bore wall of the combustion chamber;
a top annular groove in the outer surface; and
a second annular groove in the outer surface below the top annular groove;
a top piston ring in the top annular groove of the piston;
a second piston ring in the second annular groove of the piston; and
a flow path sized for substantially all gas from the combustion chamber that flows past the top piston ring into a space between the top piston ring and the second piston ring to pass through the flow path to minimize pressure buildup between the piston rings over the entire cycle under substantially all operating conditions of the internal combustion engine, the flow path being formed between adjacent ends of the second piston ring and between the bore wall of the combustion chamber and the outer surface of the piston.

19. The cylinder of claim 18, wherein the flow path has a first dimension formed by a spacing between the adjacent ends of the second piston ring and a second dimension formed by a spacing between the outer surface of the piston and the bore wall of the combustion chamber.

20. The cylinder of claim 18, wherein an area formed by the first dimension and the second dimension is at least 2.5 square millimeters.
